(19) United States
(12) Patent Application Publication
(10) Pub. No.: US 2026/0267490 A1
(43) Pub. Date: Sep. 10, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Makoto FUJINO, Osaka (JP)

(73) Assignee: PANASONIC INTELLECTUAL PROPERTY MANAGEMENT CO., LTD., Osaka (JP)

(21) Appl. No.: 19/657,444

(22) Filed: Apr. 24, 2026

Related U.S. Application Data
(63) Continuation of application No. PCT/JP2024/038793, filed on Oct. 31, 2024.
(60) Provisional application No. 63/546,973, filed on Nov. 2, 2023.

(30) Foreign Application Priority Data
Aug. 30, 2024 (JP) 2024-148683

(51) Int. Cl. G06F 3/04845; G06F 3/04817; G06T 7/73

(52) U.S. Cl. CPC G06F 3/04845; G06F 3/04817; G06T 7/74; G06T 2200/24; G06T 2207/10024; G06T 2207/20092

(57) ABSTRACT

An information processing method in a computer, the information processing method including displaying a bird's eye view on a display; displaying, on the bird's eye view, a plurality of photographing point icons indicating photographing points; detecting that a specific icon among the plurality of photographing point icons has been selected; displaying a first image associated with the specific icon on the display; detecting that a predetermined object included in the first image has been selected; and in response to selection of the predetermined object, displaying, on the display, a second image including the predetermined object photographed from a photographing point different from a photographing point of the first image, the second image being captured at a time different from a photographing time of the first image.

### FIELD OF INVENTION

The present disclosure relates to a technique for displaying an image.

### BACKGROUND ART

Patent Literature 1 discloses a technique of creating image information on which guidance information indicating a name of a street on a route on which a user is walking is superimposed, and displaying the image information on a liquid crystal display when the user has a sense of stability. Patent Literature 1 also discloses a technique of creating image information on which guidance information indicating a name of a building around a route on which a user is walking is superimposed, and outputting the image information on the liquid crystal display when the user feels a sense of spaciousness.

Patent Literature 1 merely discloses a technique of presenting, to a user, image information on which guidance information indicating names of streets and buildings is superimposed. Therefore, in the technique described in Patent Literature 1, it is not easy for the user to check an image obtained by photographing a predetermined object included in the image from another photographing point. In this case, the user may input, to a computer, manipulation for searching for an image obtained by photographing, from another photographing point, the predetermined object included in the image. As a result, the number of processing steps of the computer increases, and a load on the computer increases.

Patent Literature 1: JP 2017-167501 A

### SUMMARY OF THE INVENTION

The present disclosure has been made on the basis of the above problem, and an object of the present disclosure is to provide a technique that facilitates checking of an image of a predetermined object that is included in another image, the image being obtained by photographing from a different photographing point.

An information processing method according to one aspect of the present disclosure is an information processing method in a computer, the method including: displaying a bird's eye view on a display; displaying, on the bird's eye view, a plurality of photographing point icons indicating photographing points; detecting that a specific icon among the plurality of photographing point icons has been selected; displaying a first image associated with the specific icon on the display; detecting that a predetermined object included in the first image has been selected; and in response to selection of the predetermined object, displaying, on the display, a second image including the predetermined object photographed from a photographing point different from a photographing point of the first image, the second image being captured at a time different from a photographing time of the first image.

According to the present disclosure, since a user can easily check the second image obtained by photographing the predetermined object included in the first image from a different photographing point, it is possible to suppress an increase in a load on the computer.

### BRIEF DESCRIPTION OF THE DRAWINGS

FIG. 1 is a diagram illustrating an overall configuration of an information processing system according to the present embodiment.

FIG. 2 is a diagram illustrating an example of a design drawing displayed on a display.

FIG. 3 is a flowchart showing one example of processing in the information processing system.

FIG. 4 is a flowchart showing one example of processing in the information processing system.

FIG. 5 is a view illustrating an example of a second display region in a first image.

FIG. 6 is a diagram schematically illustrating a SLAM analysis diagram generated by a display control unit.

FIG. 7 is a diagram schematically illustrating a SLAM analysis diagram generated by the display control unit.

FIG. 8 is a view illustrating an example of a second image.

FIG. 9 is a view illustrating another example of the second image.

FIG. 10 is a diagram schematically illustrating a display screen displayed on the display in Modification (2).

FIG. 11 is a view illustrating a first image according to Modification (3).

FIG. 12 is a diagram illustrating a design drawing in which selectable areas are set.

### DETAILED DESCRIPTION

### Knowledge Underlying Present Disclosure

A user interface is being developed that displays a plurality of photographing point icons indicating photographing points at which a construction site or the like is actually photographed on a two-dimensional design drawing of the construction site or the like, and when one photographing point icon is selected, displays an image captured at a photographing point indicated by the one photographing point icon. As a result, a director of the construction site can grasp a situation of the construction site without visiting the construction site.

In the user interface described above, a user may select a specific photographing point icon, cause a display or the like to display an image (referred to as a first image) associated with the specific photographing point icon, and check a predetermined object appearing in the first image. Here, in order to grasp a structure, a shape, and the like of the predetermined object appearing in the first image in more detail, the user may desire to check a second image in which the predetermined object appears, the second image being captured from a photographing point different from the first image. In this case, the user may input, to a computer, manipulation for searching for a photographing point icon associated with an appropriate image as the second image. As a result, since the number of processing steps of the computer increases, a load on the computer increases.

Such a problem cannot be solved by the technique described in Patent Literature 1. Patent Literature 1 merely discloses a technique of superimposing a name of an object appearing in an image on the object, and does not study the above problem at all.

In order to solve the above problem, the following techniques are disclosed.

1 An information processing method according to one aspect of the present disclosure is an information processing method in a computer, the method including: displaying a bird's eye view on a display; displaying, on the bird's eye view, a plurality of photographing point icons indicating photographing points; detecting that a specific icon among the plurality of photographing point icons has been selected; displaying a first image associated with the specific icon on the display; detecting that a predetermined object included in the first image has been selected; and in response to selection of the predetermined object, displaying, on the display, a second image including the predetermined object photographed from a photographing point different from a photographing point of the first image, the second image being captured at a time different from a photographing time of the first image.

According to this configuration, in response to the selection of the predetermined object in the first image, the second image including the predetermined object photographed from the photographing point different from the photographing point of the first image is displayed on the display. Since this enables the user to easily check the second image, it is not necessary to input manipulation for searching for the second image to the computer. As a result, an increase in processing of the computer is suppressed, so that an increase in a load on the computer can be suppressed.

2 The information processing method according to (1) may further include: selecting images associated with photographing point icons present within a predetermined distance from the specific icon as second image candidates; and selecting the second image from the second image candidates.

According to this configuration, an image captured at a photographing point located within a predetermined distance from the photographing point of the first image is selected as the second image candidate. In other words, an image having a high possibility that a predetermined object photographed from a photographing point different from the first image appears is selected as the second image candidate. Then, the second image is selected from the second image candidates. This enables an appropriate image to be displayed on the display as the second image.

3 The information processing method according to (2) may further include: detecting that viewpoint switching manipulation for the first image has been input; and acquiring a manipulation amount of the viewpoint switching manipulation, and the second image candidates may include at least two images, and displaying the second image on the display may include selecting the second image from the second image candidates on the basis of the manipulation amount.

According to this configuration, the user can switch the second image displayed on the display by adjusting the manipulation amount of the viewpoint switching manipulation. This enables the user to check various second images.

4 In the information processing method according to (3), selecting the second image from the second image candidates may include: specifying a positional relationship between a photographing point of the second image candidate and a position of the predetermined object; on the basis of the positional relationship, calculating a rotation angle formed by a reference direction set in the second image candidate and a direction extending toward the predetermined object with the photographing point of the second image candidate as a starting point; and selecting the second image candidate having the rotation angle according to the manipulation amount as the second image.

According to this configuration, the second image candidate having the rotation angle according to the manipulation amount of the viewpoint switching manipulation can be displayed on the display as the second image. This enables the user to intuitively switch the image displayed as the second image.

5 The information processing method according to any one of (1) to (4) may further include acquiring a first display size of the predetermined object in the first image, and displaying the second image on the display may include: setting a second display size of the predetermined object in the second image to be the same size as the first display size by enlarging or reducing the predetermined object in the second image; and displaying the second image including the predetermined object set to the same size on the display.

According to this configuration, the second display size is set to the same size as the first display size. This enables a predetermined object to be displayed with a constant display size on the display.

6 The information processing method according to any one of (1) to (5) may further include displaying, on the display, the bird's eye view in which an attention point icon indicating a photographing point of the second image among the plurality of photographing point icons is emphasized.

According to this configuration, since the attention point icon indicating the photographing point of the second image is highlighted on the bird's eye view, the user can intuitively perceive the photographing point of the second image.

7 The information processing method according to (6) may further include setting a color of a frame surrounding the second image and a color of a frame surrounding the attention point icon to the same color.

According to this configuration, since the color of the frame surrounding the second image and the color of the frame surrounding the attention point icon are set to the same color, the user can more intuitively perceive the photographing point of the second image.

8 In the information processing method according to any one of (1) to (7), detecting that the predetermined object has been selected may include detecting an object included in the first image; displaying, on the display in an emphasized manner, an object region in which the detected object is drawn; and receiving selection of the object region.

According to this configuration, the region where the object is drawn in the first image is highlighted. Then, the user can select the object by selecting the highlighted region. This enables the user to easily select the object.

9 In the information processing method according to any one of (1) to (8), detecting that the predetermined object has been selected may include: displaying, on the display, the bird's eye view in which a selectable area is set; detecting that a user has selected a predetermined region in the selectable area; specifying a photographing point icon associated with an image obtained by photographing the predetermined region; specifying a corresponding region corresponding to the predetermined region from the image obtained by photographing the predetermined region; and estimating an object included in the corresponding region as the predetermined object.

According to this configuration, the object existing in the region selected by the user from the selectable area in the bird's eye view is estimated as the predetermined object selected by the user. This enables the user to select a predetermined object from the bird's eye view. As a result, the user can more easily select a predetermined object.

Furthermore, the present disclosure can be realized not only as the information processing method for executing the characteristic processing as described above, but also as an information processing device or the like having a characteristic configuration corresponding to the characteristic processing executed by the information processing method. Furthermore, the present disclosure can also be realized as a computer program that causes a computer to execute the characteristic processing included in the information processing method described above. Therefore, an effect similar to the effect achieved by the above information processing method can also be achieved by other modes described below.

10 An information processing device according to another aspect of the present disclosure is an information processing device including a processor, and the processor executes: displaying a bird's eye view on a display; displaying, on the bird's eye view, a plurality of photographing point icons indicating photographing points; detecting that a specific icon among the plurality of photographing point icons has been selected; displaying a first image associated with the specific icon on the display; detecting that a predetermined object included in the first image has been selected; and in response to selection of the predetermined object, displaying, on the display, a second image including the predetermined object photographed from a photographing point different from a photographing point of the first image, the second image being captured at a time different from a photographing time of the first image.

11 An information processing program according to still another aspect of the present disclosure causes a computer to execute: displaying a bird's eye view on a display; displaying, on the bird's eye view, a plurality of photographing point icons indicating photographing points; detecting that a specific icon among the plurality of photographing point icons has been selected; displaying a first image associated with the specific icon on the display; detecting that a predetermined object included in the first image has been selected; and in response to selection of the predetermined object, displaying, on the display, a second image including the predetermined object photographed from a photographing point different from a photographing point of the first image, the second image being captured at a time different from a photographing time of the first image.

The present disclosure can be also implemented as an information processing system that is operated by such information processing program described above. In addition, it is needless to say that such program can be distributed via a computer-readable non-transitory recording medium such as a CD-ROM, or via a communication network such as the Internet.

Hereinafter, embodiments of the present disclosure will be described with reference to the drawings. Note that each embodiment to be described below illustrates a specific example of the present disclosure. Numerical values, shapes, components, steps, orders of steps, and the like of the embodiments below are merely examples, and are not intended to limit the present disclosure. A component not described in an independent claim representing a most significant concept among components in the embodiments below is described as an optional component. In all the embodiments, respective contents can be combined.

### First Embodiment

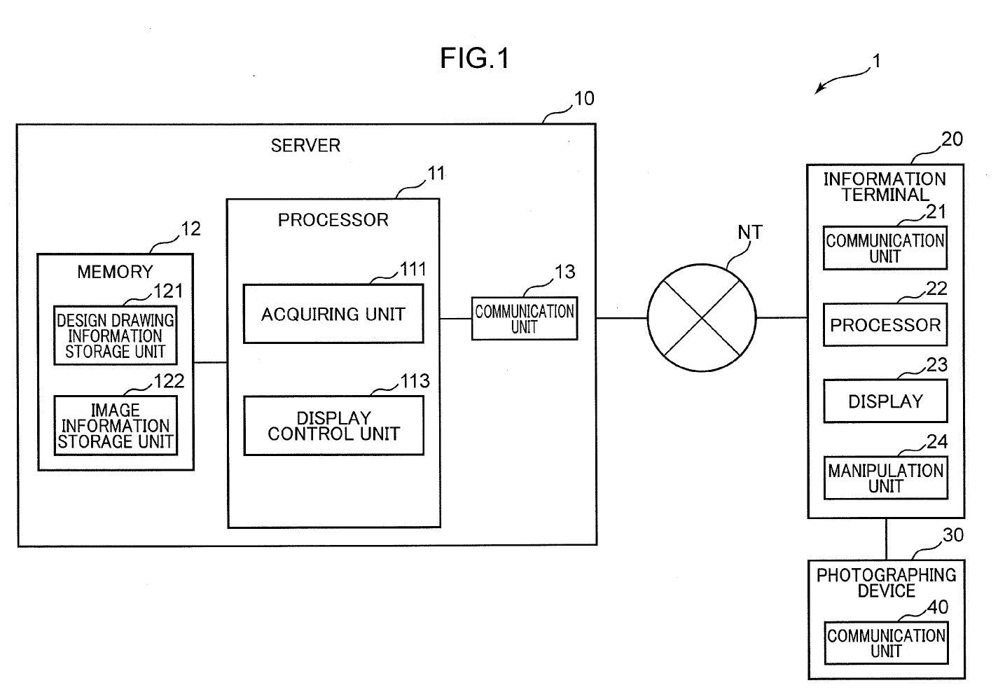

FIG. 1 is a diagram illustrating an overall configuration of an information processing system 1 according to the present embodiment.

The information processing system 1 is a system that, when receiving viewpoint switching manipulation in a state where a first image IM1 in which a predetermined object appears is displayed, displays a second image IM2 in which the predetermined object captured from another viewpoint appears. The information processing system 1 includes a server 10, an information terminal 20, and a photographing device 30.

The server 10 is an example of an information processing device and a computer. The server 10, the information terminal 20, and the photographing device 30 are communicably connected to each other via a network NT. An example of the network NT is the Internet. The server 10 is, for example, a cloud server configured by one or a plurality of computers. However, this is an example, and the server 10 may be configured by an edge server or may be implemented in the information terminal 20. A mode in which the server 10 is implemented in the information terminal 20 is an example of a mode in which the information terminal 20 is configured by an information processing device.

The information terminal 20 is a terminal manipulated by a user. The user is, for example, a director of a predetermined space photographed by the photographing device 30. The predetermined space is, for example, a building site. However, this is an example, and the predetermined space may be a construction site, a factory, a store, an office, or the like. The information terminal 20 may be configured by, for example, a portable computer such as a smartphone or a tablet computer, or may be configured by a stationary computer. Although one information terminal 20 is illustrated in the example of FIG. 1, a plurality of information terminals may be connected to the server 10 via the network NT. The information terminal 20 includes a communication unit 21, a processor 22, a display 23, and a manipulation unit 24.

The communication unit 21 is a communication interface that connects the information terminal 20 to the network NT. The communication unit 21 transmits signals indicating various instructions received from the user by the manipulation unit 24 to the server 10.

The processor 22 is configured by, for example, a central processing unit (CPU), and causes the display 23 to display a design drawing of a predetermined space transmitted from the server 10.

The display 23 is configured by one of various display devices such as a liquid crystal display and an organic EL display, and displays various display screens under the control of the processor 22. In the present embodiment, the display 23 displays a display screen for the design drawing of the predetermined space.

The manipulation unit 24 is configured by, for example, a keyboard, a touch panel, a mouse, and the like. The user inputs various instructions by manipulating the manipulation unit 24.

The photographing device 30 is configured by, for example, an omnidirectional camera, and captures an image at a predetermined frame rate. The omnidirectional camera is also referred to as a 360 degree camera, and is a camera capable of acquiring an omnidirectional image of 360 degrees. The photographing device 30 is, for example, a portable photographing device carried by a photographer. The photographer is, for example, a worker at a building site or a site supervisor. Note that the photographing device 30 may be configured by a normal camera. The photographing device 30 includes a communication unit 40. The communication unit 40 communicably connects the information terminal 20 and the photographing device 30 to each other via a near field wireless communication path such as Bluetooth (registered trademark) or a wireless LAN.

The photographer moves in the predetermined space while photographing the building site with the photographing device 30. When photographing is finished, photographing information including a series of images captured by the photographing device 30 is transferred to the information terminal 20 via the communication unit 40 and temporarily accumulated in the information terminal 20. The photographing information accumulated in the information terminal 20 is uploaded to the server 10 by manipulating the information terminal 20 by the photographer.

The photographing information includes an image captured by the photographing device 30, a photographing start point, a photographing end point, and a design drawing ID corresponding to a predetermined space. The design drawing ID is an identifier for identifying a design drawing of the predetermined space. The photographing start point and the photographing end point are added by the information terminal 20.

At the photographing start point, the photographer presses a photographing button of the photographing device 30 by directing a photographing direction of the photographing device 30 to a predetermined direction to start photographing operation. When the photographer reaches the photographing end point, the photographer presses the photographing button again to end the photographing operation. The predetermined direction is a direction to be matched with that of the design drawing displayed on the display 23. Although the predetermined direction is, for example, the north direction, it is not limited thereto.

The photographing start point and the photographing end point are specified by the photographer inputting an instruction to designate positions of the points on the display screen of the design drawing of the predetermined space displayed on the display 23 or the like of the information terminal 20. Two-dimensional coordinate axes are defined in the design drawing. Therefore, the photographing start point and the photographing end point are respectively defined by the two-dimensional coordinate values. The photographing start point and the photographing end point are used by the server 10 to specify a position of each photographing point and a photographing direction of each image.

The server 10 includes a processor 11, a memory 12, and a communication unit 13. The processor 11 includes, for example, a central processing unit (CPU), a graphics processing unit (GPU), or the like. The processor 11 includes an acquiring unit 111 and a display control unit 113. The acquiring unit 111 and the display control unit 113 may be implemented by the processor 11 executing an information processing program, or may be configured by a dedicated hardware circuit such as an ASIC.

The acquiring unit 111 acquires the photographing information transmitted from the photographing device 30 by using the communication unit 13. The acquiring unit 111 communicates with the information terminal 20 to acquire a display instruction from the information terminal 20. The display instruction is an instruction input by the user to the information terminal 20, and is an instruction to display the design drawing on the display 23. The acquiring unit 111 communicates with the information terminal 20 to acquire a selection instruction to select a photographing point icon. The selection instruction is an instruction indicating that the user has selected one of the photographing point icons displayed in the design drawing.

A photographing point calculation unit 112 acquires a photographing point of each of a plurality of images captured by the photographing device 30 using the photographing information acquired by the acquiring unit 111. The photographing point calculation unit 112 calculates a photographing point of each image using self-localization processing. Visual simultaneous localization and mapping (VSLAM) can be adopted as the self-localization processing. For example, the photographing point calculation unit 112 detects a feature point by image processing from each of the plurality of images included in the photographing information. The feature point is a characteristic point indicating a contour or the like of an object included in the image. Using at least two images among a plurality of images in which the feature points are set, the photographing point calculation unit 112 executes the self-localization processing for each of the plurality of images to calculate a relative coordinate value of a photographing point that is a self-position corresponding to each image. Using the relative coordinate value, the photographing point calculation unit 112 creates a SLAM analysis diagram. The SLAM analysis diagram is a virtual map generated by mapping a photographing point of each image on a two-dimensional coordinate system.

In addition, on the basis of a design drawing, coordinate values of the photographing start point on the design drawing and the photographing end point on the design drawing, and the plurality of images, the photographing point calculation unit 112 estimates a series of photographing points from the photographing start point to the photographing end point in the design drawing. Then, a plurality of photographing point icons indicating photographing positions on the design drawing of the series of photographing points are created, and the photographing point icons are superimposed on the design drawing.

The display control unit 113 displays a display screen of the design drawing on the display 23 of the information terminal 20 in response to the acquiring unit 111 acquiring the display instruction. In response to the selection instruction to select a photographing point icon, the display control unit 113 displays, on the display 23 of the information terminal 20, an image captured at the photographing point indicated by the photographing point icon.

The design drawing is one example of a bird’s-eye view. The display instruction for the design drawing includes the design drawing ID. The display control unit 113 only needs to read a design drawing indicated by the design drawing ID from a design drawing information storage unit 121 and display a display screen of the read design drawing on the display 23.

The design drawing is a bird's eye view of a building including pillars, walls, or materials. The design drawing is a drawing illustrating a design of a building site, and may be a plan view, a blueprint, a map, a perspective view, or the like of the building site. The bird’s-eye view can also be referred to as an overhead view, and may be an overview or a view from high above.

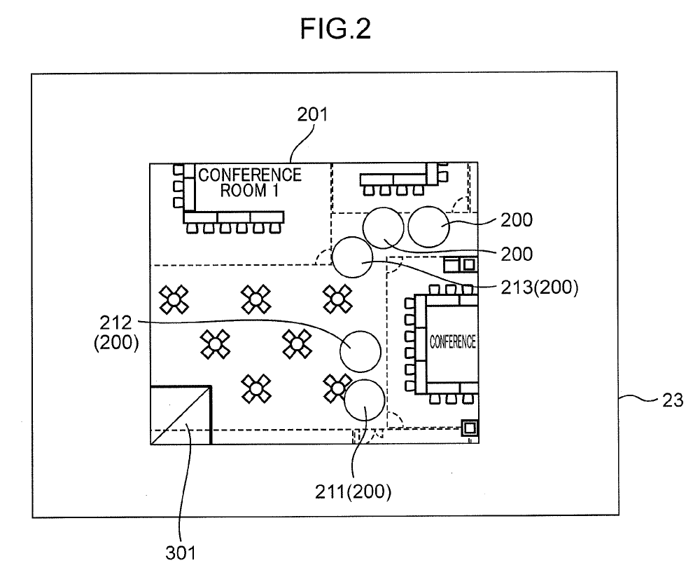

FIG. 2 is a diagram illustrating a design drawing 201 which is an example of a design drawing displayed on the display 23. As illustrated in FIG. 2, a plurality of photographing point icons 200 are displayed in the design drawing 201. Specifically, the plurality of photographing point icons 200 include photographing point icons 211 to 213. Each of the photographing point icons 211 to 213 is associated with an image captured at its photographing point.

When detecting that a specific icon among the plurality of photographing point icons 200 has been selected, the display control unit 113 displays the first image IM1 associated with the specific icon on the display 23.

The display control unit 113 also detects that a predetermined object included in the first image IM1 has been selected by the user. In response to this detection, the display control unit 113 displays, on the display 23, a second image IM2 including a predetermined object photographed from a photographing point different from a photographing point at which the first image IM1 was captured, the second image IM2 being captured at a time different from a time at which the first image IM1 was captured. Details will be described later.

The memory 12 is configured by a nonvolatile rewritable storage device such as a hard disk drive or a solid state drive. The memory 12 includes the design drawing information storage unit 121 and an image information storage unit 122. The design drawing information storage unit 121 stores design drawing information. The design drawing information is an image indicating a design drawing of a predetermined space. The design drawing information is associated with a design drawing ID for identifying a design drawing.

The image information storage unit 122 stores image information including the photographing information transmitted from the photographing device 30. The image information includes meta information of each image in addition to a plurality of images, a photographing start point, a photographing end point, and a design drawing ID included in the photographing information transmitted from the photographing device 30. The image information is generated every time the photographing information described above is transmitted. The meta information includes a photographing ID, a photographing period ID, a photographing time, a photographing direction, and a photographing point.

The photographing ID is an identifier of a photographing point. The photographing period ID is an identifier of a photographing period. The photographing period represents a period from start to end of the photographing operation. The photographing time is photographing date and time of an image. The photographing direction is a photographing direction of each image in the photographing device 30. The photographing point is configured by a position (two-dimensional coordinate value) indicating a photographing point of an image on the SLAM analysis diagram.

The communication unit 13 is a communication interface that connects the server 10 to the network.

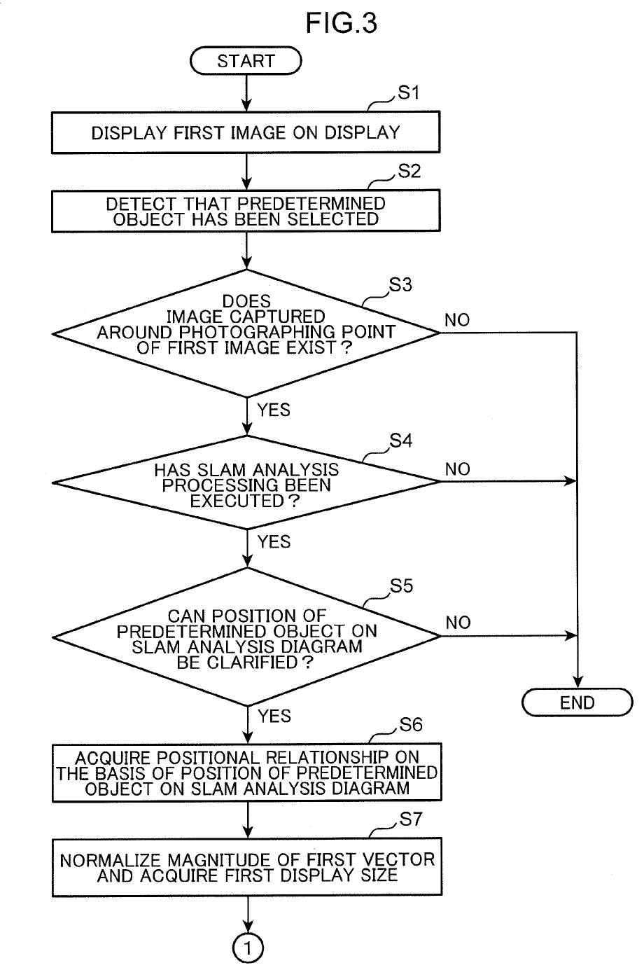

Next, processing of the information processing system 1 will be described. FIG. 3 is a flowchart showing one example of a flow of the processing executed in the information processing system 1. For example, by using, as a trigger, selection of an arbitrary photographing point icon from the design drawing 201 (FIG. 2) displayed on the display 23 by the user, processing of step S1 illustrated in FIG. 3 is started. Note that the display control unit 113 executes the above-described SLAM analysis processing as preprocessing performed before the processing of step S1 in FIG. 3 is started. Hereinafter, the processing of the information processing system 1 will be described by exemplifying a case where the user selects the photographing point icon 211 among the plurality of photographing point icons 200 as a specific icon.

In step S1, the display control unit 113 displays the first image IM1 on the display 23. Specifically, the display control unit 113 displays the first image IM1 associated with the specific icon 211 selected by the user on the display 23.

Note that the first image IM1 is an image captured using a 360 degree camera. It is difficult to display the entire image captured by the 360 degree camera on the display 23 at a time due to its characteristics. Therefore, when displaying the first image IM1 on the display 23, the display control unit 113 extracts a part of a region from the entire first image IM1 and displays the part of the region on the display 23. Hereinafter, a region that is a part of the entire first image IM1 and is first displayed on the display 23 when the first image IM1 is displayed on the display 23 is referred to as a first display region.

In step S2, the display control unit 113 detects that a predetermined object included in the first image IM1 has been selected. First, in step S2, the user searches for the predetermined object in the first display region. Here, in a case where the predetermined object is not included in the first display region, the user inputs display region change manipulation. The display region change manipulation is manipulation for causing a region different from the first display region in the first image IM1 to be displayed on the display 23. Hereinafter, a region that is a part of the entire first image IM1 and is displayed on the display 23 when the display region change manipulation is input is referred to as a second display region. The display region change manipulation is realized by, for example, swipe manipulation. In other words, the user moves his/her finger in a predetermined direction while pressing his/her finger against the display 23. As a result, the viewpoint of the first image IM1 is rotated, and the second display region is displayed on the display 23. Note that the swipe manipulation is merely an example, and the display region change manipulation may be realized by, for example, drag manipulation using a mouse.

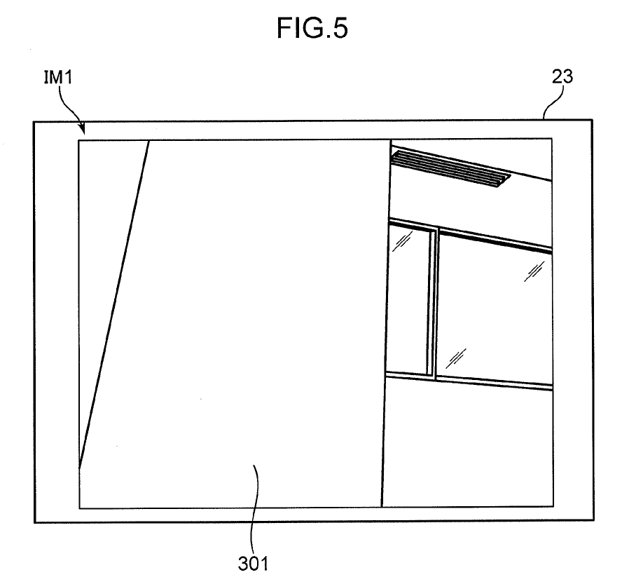

FIG. 5 is a view illustrating an example of the second display region of the first image IM1. As illustrated in FIG. 5, the second display region includes a pillar 301. Hereinafter, an example in which the user selects the pillar 301 as a predetermined object will be described. The user selects an object, for example, by inputting the drag manipulation by which a mouse cursor moves between two points including a vertex of the pillar 301 or by clicking a part of the pillar 301.

In step S3, the display control unit 113 determines whether or not there is an image captured around a photographing point of the first image IM1. For example, the display control unit 113 determines whether or not at least one photographing point icon 200 exists within a predetermined distance from the specific icon 211 in the design drawing 201 illustrated in FIG. 2. When at least one photographing point icon 200 exists within the predetermined distance (YES in step S3), the processing proceeds to step S4. On the other hand, when the photographing point icon 200 does not exist within the predetermined distance (NO in step S3), the processing ends.

Meanwhile, the photographing device 30 according to the present embodiment captures an image at a predetermined frame rate (e.g., 30 frames per second). In a case where the photographing point icon 200 is generated for each of these images and all the photographing point icons 200 are superimposed on the design drawing 201, many photographing point icons 200 are arranged in the design drawing 201, and visibility of the design drawing 201 is deteriorated. Therefore, with respect to a part of images among the plurality of images captured by the photographing device 30, even if its photographing point is estimated by the SLAM processing, the photographing point icon 200 indicating the photographing point is not generated. Hereinafter, such an image is referred to as a thinned image. A thinned image and Information indicating a photographing point of the thinned image are stored, for example, in a predetermined storage region of the image information storage unit 122. In step S3, in addition to the above-described determination processing, the display control unit 113 may determine whether or not there is a photographing point of the thinned image within the predetermined distance from the specific icon 211. Then, when the photographing point of the thinned image exists within the predetermined distance, the display control unit 113 may determine YES in step S3.

In step S4, the display control unit 113 determines whether or not the SLAM analysis processing has been executed. Specifically, the display control unit 113 determines whether or not the photographing point calculation unit 112 has executed the SLAM analysis processing using the first image IM1 and images captured around the first image IM1. When the SLAM analysis processing has been performed (YES in step S4), the processing proceeds to step S5. On the other hand, when the SLAM analysis processing has not been performed (NO in step S4), the processing ends.

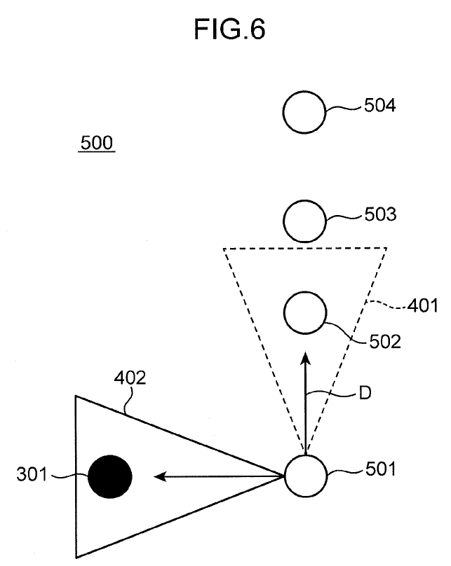

In step S5, the display control unit 113 determines whether or not the position of the predetermined object on the SLAM analysis diagram can be clarified. FIG. 6 is a diagram for explaining the processing in step S5, and is a diagram schematically illustrating a SLAM analysis diagram 500 generated by the display control unit 113. As illustrated in FIG. 6, a first photographing point 501, a second photographing point 502, a third photographing point 503, and a fourth photographing point 504 are mapped in the SLAM analysis diagram 500. The first photographing point 501 indicates a photographing point on the SLAM analysis diagram 500 of the first image IM1. The second photographing point 502 to the fourth photographing point 504 indicate positions of images captured around the first photographing point 501 on the SLAM analysis diagram 500. Hereinafter, the image captured at the second photographing point 502 is referred to as an image A, the image captured at the third photographing point 503 is referred to as an image B, and the image captured at the fourth photographing point 504 is referred to as a C image. The first photographing point 501 corresponds to the specific icon 211 in the design drawing 201 of FIG. 2. The second photographing point 502 corresponds to the photographing point icon 212 in the design drawing 201. The fourth photographing point 504 corresponds to the photographing point icon 213 in the design drawing 201. The image B captured at the third photographing point 503 is a thinned image, and a photographing point icon indicating the photographing point of the image B is not displayed in the design drawing 201.

In step S5, the display control unit 113 estimates a position of the predetermined object (pillar 301) on the SLAM analysis diagram 500 on the basis of a manipulation amount of the display region change manipulation executed by the user in step S2. For example, when the user performs the swipe manipulation (referred to as first swipe manipulation) for changing the display region in step S2, the position of the pillar 301 on the SLAM analysis diagram 500 is estimated on the basis of a swipe amount of the first swipe manipulation.

First, on the SLAM analysis diagram 500, the display control unit 113 specifies a first visual field range 401 (FIG. 6), which is a visual field range of the first display region using a position of the first photographing point 501 on the SLAM analysis diagram, a reference direction D preset in the first image IM1, and an angle of view of the first display region of the first image IM1 in a left-right direction. Note that the reference direction D is, for example, a direction corresponding to a front direction of the photographing device 30. In addition, the reference direction D may be arbitrarily set by an operator. The first visual field range 401 is a fan-shaped region extending from the first photographing point 501 along the reference direction D, and is a region whose viewing angle is defined by the angle of view of the first display region in the left-right direction.

Subsequently, the display control unit 113 specifies a second visual field range 402 (FIG. 6) on the SLAM analysis diagram 500 on the basis of the swipe amount of the first swipe manipulation input by the user in step S2. For example, it is assumed that in step S2, the user inputs the first swipe manipulation of rotating the viewpoint by 90 degrees from the reference direction D. As a result, it is assumed that the second display region of the first image IM1 illustrated in FIG. 5 is displayed. In this case, the display control unit 113 specifies a fan-shaped region extending in a direction rotated by 90 degrees with respect to the reference direction D as the second visual field range 402 on the SLAM analysis diagram 500. The second visual field range 402 is a region whose viewing angle is defined by an angle of view of the second display region in the left-right direction.

Subsequently, the display control unit 113 estimates a position of the pillar 301 within the second visual field range 402 by performing predetermined image processing on the second display region of the first image IM1. Then, the position of the pillar 301 is mapped on the SLAM analysis diagram 500.

When the position of the pillar 301 could be mapped on the SLAM analysis diagram, the display control unit 113 determines YES in step S5. In this case, the processing proceeds to step S6. On the other hand, when the position of the pillar 301 could not be mapped on the SLAM analysis diagram, determination of NO is made in step S5. In this case, the processing ends.

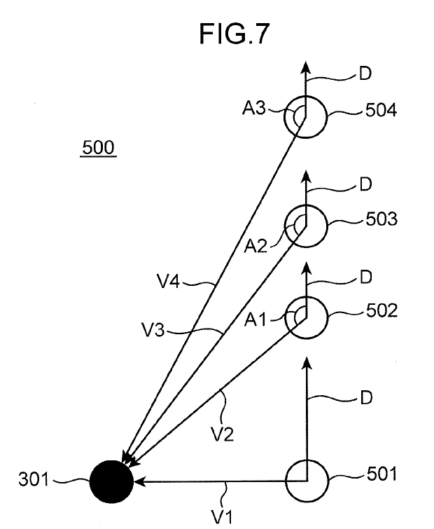

In step S6, the display control unit 113 specifies a positional relationship on the basis of the position of the predetermined object (pillar 301) on the SLAM analysis diagram 500. FIG. 7 is a diagram for explaining processing in step S6, and is a diagram schematically illustrating the SLAM analysis diagram 500 generated by the display control unit 113.

First, the display control unit 113 specifies a positional relationship between the position of the first photographing point 501 on the SLAM analysis diagram 500 and the position of the pillar 301. Specifically, the display control unit 113 sets, on the SLAM analysis diagram 500, a first vector V1 (FIG. 7) extending from the first photographing point 501 as a starting point toward the pillar 301. Then, the display control unit 113 acquires a magnitude and a direction of the first vector V1.

Subsequently, the display control unit 113 specifies a positional relationship between the position of the pillar 301 and a position of each of the second to fourth photographing points 502 to 504 on the SLAM analysis diagram 500. Specifically, the display control unit 113 sets a second vector V2 extending from the second photographing point 502 as a starting point toward the pillar 301 on the SLAM analysis diagram 500. Then, a magnitude and a direction of the second vector V2 are acquired. Similarly, the display control unit 113 acquires a magnitude and a direction of a third vector V3 extending from the third photographing point 503 as a starting point toward the pillar 301. In addition, the display control unit 113 acquires a magnitude and a direction of a fourth vector V4 extending from the fourth photographing point 504 as a starting point toward the pillar 301.

Subsequently, the display control unit 113 calculates a first rotation angle A1 (FIG. 7) formed by the reference direction D set in the image A captured at the second photographing point 502 and the second vector V2. For example, the display control unit 113 calculates that the first rotation angle A1 is 120 degrees. In addition, the display control unit 113 calculates a second rotation angle A2 formed by the reference direction D set in the image B captured at the third photographing point 503 and the third vector V3. For example, the display control unit 113 calculates that the second rotation angle A2 is 135 degrees. In addition, the display control unit 113 calculates a third rotation angle A3 formed by the reference direction D set in the image C captured at the fourth photographing point 504 and the fourth vector V4. For example, the display control unit 113 calculates that the third rotation angle A3 is 160 degrees.

In step S7, the display control unit 113 normalizes the magnitude of the first vector V1 and acquires a first display size of the pillar 301 appearing in the first image IM1. The display control unit 113 stores the normalized magnitude of the first vector V1 and the first display size in the predetermined storage region of the memory 12. The first display size is defined by a ratio of the pillar 301 appearing in the second display region of the first image IM1 to the entire screen of the display 23.

In step S8, the display control unit 113 displays, on the display 23, a user interface (hereinafter, referred to as a viewpoint switching UI) enabling switching of a viewpoint with a predetermined object as a starting point. For example, the display control unit 113 displays a button including a text such as "viewpoint switching mode" on the display 23. Then, when detecting that this button is pressed (selected) by the user, the display control unit 113 displays an initial screen of the viewpoint switching UI on the display 23. For example, the display control unit 113 displays the second display region of the first image IM1 on the display 23 as the initial screen. When the initial screen of the viewpoint switching UI is displayed, the user inputs, to the first image IM1, the viewpoint switching manipulation for switching the viewpoint. The switching of the viewpoint represents displaying, on the display 23, the second image IM2 including a predetermined object photographed from a photographing point different from the photographing point where the first image IM1 has been captured. In other words, it means that the pillar 301 photographed from another angle is displayed on the display 23. The viewpoint switching manipulation is realized by, for example, the swipe manipulation. However, this is merely an example, and the viewpoint switching manipulation may be realized by, for example, the drag manipulation. Hereinafter, swipe manipulation performed by the user to switch the viewpoint is referred to as second swipe manipulation.

In step S9, the display control unit 113 determines whether or not the user has performed manipulation intended to switch the viewpoint with respect to the predetermined object (pillar 301). In other words, it is determined whether or not the user has executed the second swipe manipulation on the first image IM1. When the input of the second swipe manipulation has been detected (YES in step S9), the processing proceeds to step S10. When the input of the second swipe manipulation has not been detected (NO in step S9), the processing returns to step S8.

In step S10, the display control unit 113 acquires a second manipulation amount indicating a manipulation amount of the viewpoint switching manipulation (the second swipe manipulation). In other words, the display control unit 113 grasps how much the user has moved his/her finger in the second swipe manipulation.

In step S11, the display control unit 113 selects the second image IM2 on the basis of the manipulation amount of the viewpoint switching manipulation for the first image IM1. In detail, the display control unit 113 selects the second image IM2 from second image candidates on the basis of the second manipulation amount.

The second image candidates are constituted by images captured from a photographing point located within a predetermined distance from the first photographing point 501. The display control unit 113 selects, as the second image candidate, an image having a high possibility that the pillar 301 photographed from a photographing point different from the first image appears. Specifically, the display control unit 113 selects the second image candidate using a positional relationship between a photographing point of each image and a position where the pillar 301 is present and using a photographing direction of each image. In other words, an image captured around the first image IM1 and captured in a direction in which the pillar 301 is present is selected as the second image candidate. In the present embodiment, since photographing using the 360 degree camera is performed, an image captured around the photographing point of the first image IM has a high possibility of having the pillar 301 appearing. Therefore, the display control unit 113 according to the present embodiment selects an image captured within the predetermined distance from the first photographing point 501 as the second image candidate. For example, the image A captured at the second photographing point 502, the image B captured at the third photographing point 503, and the image C captured at the fourth photographing point 504 are selected as the second image candidates. However, this is merely an example, and more or fewer second image candidates may be selected. For example, the second image candidate may be a single candidate.

In step S11, the display control unit 113 selects a second image candidate having a rotation angle corresponding to the second manipulation amount as the second image IM2. As an example, a case where the second manipulation amount is small, i.e., a case where the user slightly moves his/her finger during the second swipe manipulation is assumed. In this case, the display control unit 113 selects an image captured from a photographing point having the smallest rotation angle as the second image IM2. As described above, the first rotation angle A1 (120 degrees in this example) is the smallest among the first rotation angle A1, the second rotation angle A2, and the third rotation angle A3 shown in FIG. 7. Therefore, the display control unit 113 selects the image A, which is an image captured from the second photographing point 502, as the second image IM2.

As another example, a case where the second manipulation amount is medium, i.e., a case where the user moves his/her finger moderately during the second swipe manipulation is assumed. In this case, the display control unit 113 selects an image captured from a photographing point having the second smallest rotation angle as the second image IM2. Specifically, the image B captured from the third photographing point 503 (FIG. 7) is selected as the second image IM2.

As still another example, in a case where the second manipulation amount is large, i.e., in a case where the user greatly moves his/her finger at the time of the second swipe manipulation, the display control unit 113 selects an image captured from a photographing point having the largest rotation angle as the second image IM2. Specifically, the image C captured from the fourth photographing point 504 (FIG. 7) is selected as the second image IM2.

The display control unit 113 only needs to determine a magnitude of the second manipulation amount on the basis of whether or not an amount of movement of the user's finger exceeds a predetermined threshold value. For example, in a case where the amount of movement of the user's finger on the display 23 is less than 100 pixels, the display control unit 113 determines that the second manipulation amount is small. Furthermore, in a case where the amount of movement of the user's finger on the display 23 is, for example, 100 pixels or more and less than 200 pixels, the display control unit 113 determines that the second manipulation amount is medium. Furthermore, in a case where the amount of movement of the user's finger on the display 23 is, for example, 200 pixels or more, the display control unit 113 determines that the second manipulation amount is large. However, these numerical values are merely examples, and the threshold value can be appropriately changed according to a size of the display 23 or the like. In addition, when there are more second image candidates, the second manipulation amount may be divided in more detail by setting more threshold values.

In step S12, the display control unit 113 sets an angle of view of the second image IM2. As described above, since the second image IM2 is an image captured by the 360 degree camera, it is difficult to display the entire second image IM2 on the display 23 at a time. Therefore, when displaying the second image IM2 on the display 23, the display control unit 113 extracts a part of the region of the entire second image IM2 to display the part of the region on the display 23. Hereinafter, a region that is a part of the entire second image IM2 and is first displayed on the display 23 is referred to as an initial region. It is desirable that the pillar 301 appears in this initial region. If the pillar 301 does not appear in the initial region, the user is forced to perform complicated work such as finding a region where the pillar 301 exists in the second image IM2 by rotating a viewpoint of the second image IM2 or the like. In step S12, the angle of view of the second image IM2 is set such that the pillar 301 appears in the initial region. For example, it is assumed that the display control unit 113 selects the image A captured at the second photographing point 502 as the second image IM2. In this case, the display control unit 113 sets the center of the angle of view of the second image IM2 in a direction in which the second vector V2 extends. In other words, the angle of view of the second image IM2 is set such that the field of view spreads in a direction in which the pillar 301 exists. Similarly, the angle of view of the second image IM2 is set with reference to a direction in which the third vector V3 extends when the image B captured from the third photographing point 503 is selected as the second image IM2, and with reference to a direction in which the fourth vector V4 extends when the C image captured from the fourth photographing point 504 is selected as the second image IM2. As a result, when the image displayed on the display 23 is switched from the first image IM1 to the second image IM2, the second image IM2 in which the pillar 301 appears can be presented to the user. In other words, it is possible to present the second image IM2 whose viewpoint is directed in the direction in which the pillar 301 exists to the user.

In step S13, the display control unit 113 determines whether magnitudes of the vectors are different from each other. Specifically, it is determined whether or not a magnitude of the first vector V1 extending from the first photographing point 501 toward the pillar 301 is different from a magnitude of a vector extending from the photographing point of the second image IM2 toward the direction in which the pillar 301 exists. For example, it is assumed that the image A captured at the second photographing point 502 is selected as the second image IM2. In this case, the display control unit 113 compares the magnitude of the first vector V1 with the magnitude of the second vector V2 to determine whether the magnitudes of these vectors are different from each other or not. When the vectors have different magnitudes (YES in step S 13), the processing proceeds to step S14. When the vectors have the same magnitude (NO in step S 13), the processing ends.

In step S14, the display control unit 113 adjusts a display size (referred to as a second display size) of the pillar 301 appearing in the second image IM2 to the first display size. The second display size is defined by a ratio of the pillar 301 included in the second image IM2 to the entire screen of the display 23.

In a case where the vector of the second image IM2 is larger than the vector of the first image IM1, i.e., when the second image IM2 is an image obtained by photographing the pillar 301 from a photographing point farther than the photographing point of the first image IM1, the pillar 301 appears smaller in the second image IM2 than in the first image IM1. In this case, the display control unit 113 adjusts the second display size to the first display size by enlarging a part where the pillar 301 is drawn in the second image IM2 with reference to the first display size.

In addition, in a case where the vector of the second image IM2 is smaller than the vector of the first image IM1, i.e., in a case where the second image IM2 is an image obtained by photographing the pillar 301 from a photographing point closer than the photographing point of the first image IM1, the pillar 301 appears larger in the second image IM2 than in the first image IM1. In this case, the display control unit 113 adjusts the second display size to the first display size by reducing the part where the pillar 301 is drawn in the second image with reference to the first display size.

In other words, in step S14, the display control unit 113 sets the second display size to the same size as the first display size by enlarging or reducing the pillar 301 in the second image IM2. In this way, the second image IM2 including the pillar 301 set to the same size as the first display size can be displayed on the display 23. In other words, the pillar 301 can be displayed with a constant display size on the display 23 at all times. When it is difficult to completely match the first display size and the second display size, the display control unit 113 may substantially match the first display size and the second display size.

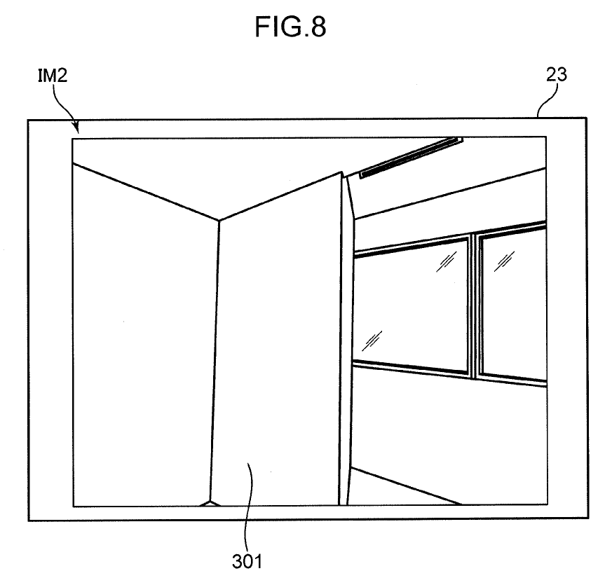

In step S15, the display control unit 113 displays the second image IM2 on the display 23. FIG. 8 is a view illustrating an example of the second image IM2. FIG. 8 illustrates an image captured at the second photographing point 502. In the present embodiment, when the second manipulation amount of the second swipe manipulation is small, the second image IM2 illustrated in FIG. 8 is displayed on the display 23. As illustrated in FIG. 8, the pillar 301 photographed from a photographing point (angle) different from the first image IM1 appears in the second image IM2.

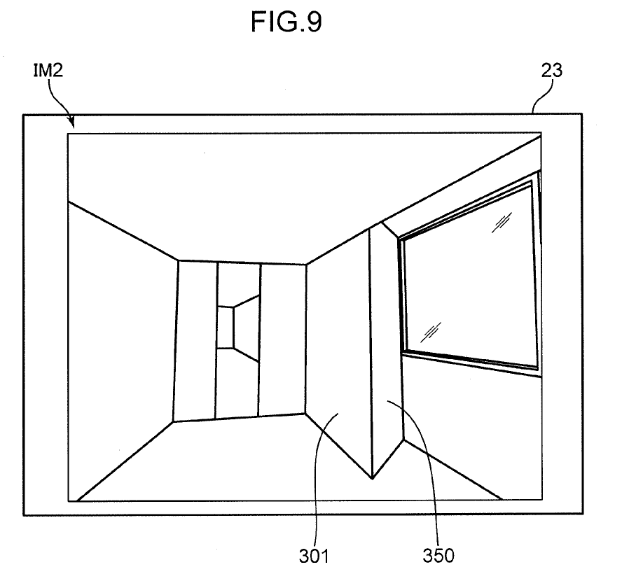

FIG. 9 is a view illustrating another example of the second image IM2. FIG. 9 illustrates an image captured at the third photographing point 503. In the present embodiment, when the second manipulation amount of the second swipe manipulation is medium, the second image IM2 illustrated in FIG. 9 is displayed on the display 23. A side surface 350 of the pillar 301 appears in the second image IM2 illustrated in FIG. 9. The side surface 350 is a part not appearing in the first image IM1 illustrated in FIG. 3.

In this manner, the user can perceive a shape and a structure of the pillar 301 by checking the second image IM2 in which the pillar 301 photographed from a photographing point different from the first image IM1 appears.

Note that the display control unit 113 may further receive the viewpoint switching manipulation after displaying the second image IM2. For example, when the viewpoint switching manipulation is further received after the second image IM2 illustrated in FIG. 8 is displayed, the second image IM2 illustrated in FIG. 9 may be displayed on the display 23.

According to the information processing system 1 described in the foregoing, in response to the selection of the pillar 301 in the first image IM1, the second image IM2 including the pillar 301 photographed from a photographing point different from the photographing point of the first image IM1 is displayed on the display 23. This enables the user to easily check the second image IM2, so that it is not necessary to input manipulation for searching for the second image IM2 to the server 10 or the like. As a result, an increase in the processing of the server 10 and the like is suppressed, so that an increase in a load on the server 10 and the like can be suppressed.

Furthermore, according to the above configuration, the user can grasp a structure and a configuration of a predetermined object in more detail.

Furthermore, in the information processing system 1, the angle of view of the second image IM2 is adjusted in advance such that the pillar 301 appears in the initial region of the second image IM2. In this way, the user does not need to search the second image IM2 for the pillar 301. As a result, the user can efficiently check the shape and the structure of the pillar 301.

Furthermore, the information processing system 1 does not generate a photographing point icon of a thinned image in order to ensure visibility and ease of manipulation of the design drawing 201. On the other hand, in a case where the thinned image is an image captured around the first image IM1, the thinned image is also used as the second image candidate. This makes it possible to both make the design drawing 201 easy to see and manipulate, and check the pillar 301 from a different viewpoint at the same time.

The present disclosure can adopt the following modifications.

(1) In step S3 of the first embodiment, when the display control unit 113 determines that the photographing point of the thinned image exists within the predetermined distance from the specific icon 211, a photographing point icon (hereinafter, referred to as a thinned image icon) indicating the photographing point of the thinned image may be newly generated. Then, the thinned image icon may be superimposed on the design drawing 201. Furthermore, a display mode of the thinned image icon may be different from a display mode of a photographing point icon other than the thinned image icon. For example, a display color of the thinned image icon on the design drawing 201 may be different from a display color of a photographing point icon other than the thinned image icon.

(2) The display control unit 113 may change a display mode of the attention point icon indicating the photographing point of the second image IM2 in the design drawing 201 in conjunction with displaying the second image IM2 on the display 23.

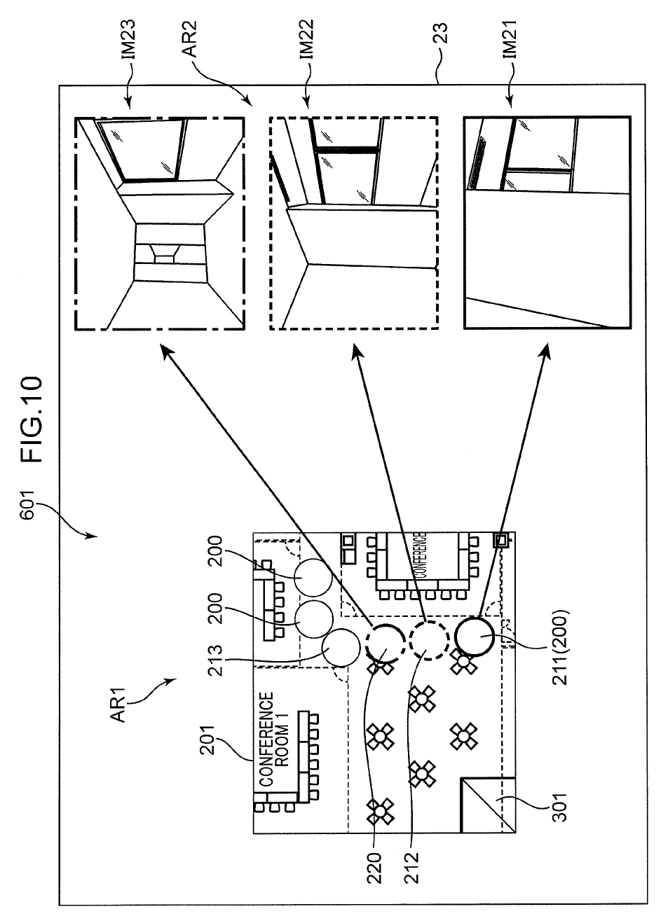

FIG. 10 is a diagram schematically illustrating a display screen 601 displayed on the display 23 in the present modification. The display screen 601 includes a design drawing display region AR1 and a second image display region AR2. In the design drawing display region AR1, the design drawing 201 on which the plurality of photographing point icons 200 are superimposed is displayed. The second image IM2 is displayed in the second image display region AR2.

For example, it is assumed that a second image IM2 (referred to as a second image IM21) captured at the photographing point indicated by the photographing point icon 211 in FIG. 10 is displayed in the second image display region AR2. In this case, the display control unit 113 causes a red frame surrounding a contour of the photographing point icon 211 to be displayed in the design drawing display region AR1. Furthermore, the display control unit 113 causes a red frame surrounding the second image IM21 to be displayed in the second image display region AR2. In other words, the color of the frame surrounding the attention point icon and the color of the frame surrounding the second image IM2 are set to the same color. As a result, the display control unit 113 highlights the photographing point icon 211 (an example of the attention point icon). In other words, a display mode of the photographing point icon 211 is made different from display modes of the photographing point icons other than the photographing point icon 211. Note that in FIG. 10, the red frame is indicated by a thick solid line.

As another example, it is assumed that a second image IM2 (referred to as a second image IM22) captured at the photographing point indicated by the photographing point icon 212 in FIG. 10 is displayed in the second image display region AR2. In this case, the display control unit 113 causes a blue frame surrounding the photographing point icon 212 and a blue frame surrounding the second image IM22 to be displayed on the display screen 601. By doing so, the display control unit 113 highlights the photographing point icon 212. In FIG. 10, the blue frame is indicated by a broken line.

As still another example, it is assumed that a second image IM2 (referred to as a second image IM23) captured at a photographing point indicated by a photographing point icon 220 in FIG. 10 is displayed in the second image display region AR2. In this case, the display control unit 113 causes a green frame surrounding the photographing point icon 220 and a green frame surrounding the second image IM23 to be displayed on the display screen 601. By doing so, the display control unit 113 highlights the photographing point icon 220. In FIG. 10, the green frame is indicated by a chain line. The photographing point icon 220 is a thinned image icon.

As described in the foregoing, in the present modification, the second image IM2 and the design drawing 201 in which the attention point icon indicating the photographing point of the second image IM2 is emphasized are displayed on the same screen of the display 23. In this way, the user can intuitively perceive the position, on the design drawing 201, of the second image IM2 currently displayed on the display 23.

In particular, in the present modification, by setting the color of the frame surrounding the attention point icon and the color of the frame surrounding the second image IM2 to the same color, the attention point icon is highlighted. This enables the user to more intuitively perceive the photographing point of the second image IM2 on the design drawing 201.

Note that the display control unit 113 may emphasize the attention point icon by various modes such as causing the attention point icon to blink, making a radius of the attention point icon larger than a radius of the ordinary photographing point icon 200, and the like.

(3) Although in the first embodiment, the example in which the user selects a predetermined object by designating a contour of the predetermined object has been described, the selection of the object may be realized by the following modes.

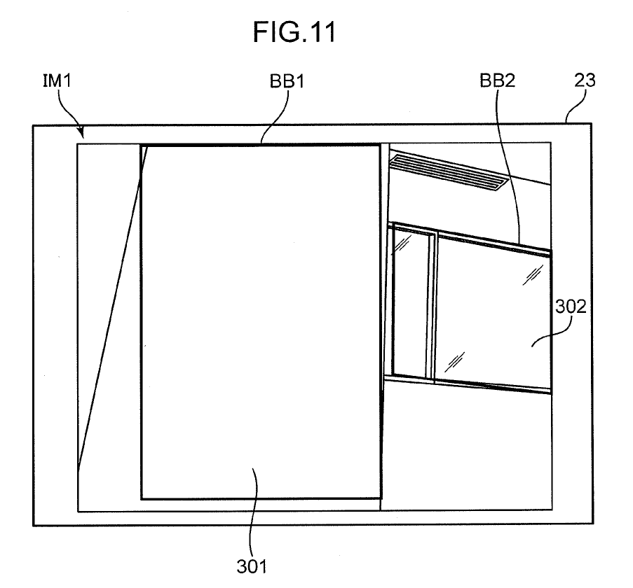

The display control unit 113 according to the present modification executes object recognition processing and boundary recognition processing on the first image IM1 to detect an object included in the first image IM1. Then, the display control unit 113 displays, on the display 23 in an emphasized manner, a region where the object is drawn. FIG. 11 is a view illustrating an example of the first image IM1 according to the present modification. For example, it is assumed that the pillar 301 and a window 302 illustrated in FIG. 11 are detected as objects included in the first image IM1. In this case, the display control unit 113 causes a bounding box BB1 and a bounding box BB2 to be displayed around a region (an example of an object region) where the pillar 301 and the window 302 are drawn. Other than the above, highlighting may be realized by various modes such as coloring the pillar 301 and the window 302, increasing brightness of the pillar 301 and the window 302, and the like.

Then, the user selects an arbitrary object region among the object regions emphasized in the first image IM1. For example, the user moves a mouse pointer to a region where the pillar 301 is drawn in the first image IM1, i.e., a region surrounded by the bounding box BB1, and clicks the mouse or the like to select the region. The display control unit 113 that has received the above manipulation detects that the predetermined object has been selected. According to the present modification, the user can more easily select a predetermined object.

(4) The display control unit 113 may display, on the display 23, a design drawing in which a selectable area 203 is set. In addition, it may be detected that the user has selected a predetermined region in the selectable area 203, and a photographing point icon associated with an image obtained by photographing the predetermined region may be specified. Then, a corresponding region corresponding to the predetermined region may be specified from the image obtained by photographing the predetermined region, and an object included in the corresponding region may be estimated as a predetermined object.

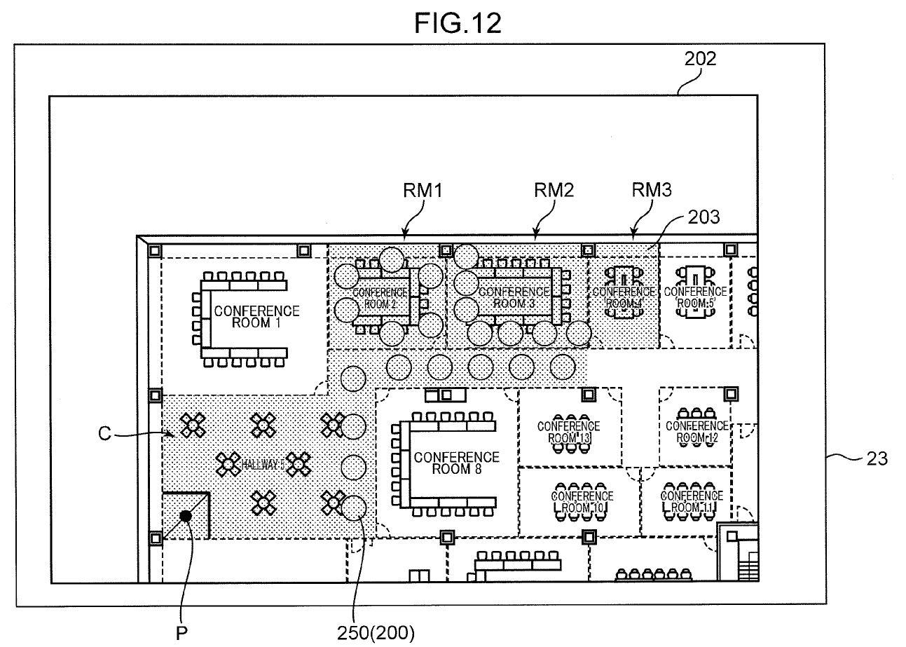

The display control unit 113 according to the present modification first creates a bird's eye view in which the selectable area 203 is set. FIG. 12 is a diagram illustrating an example of a design drawing 202 (an example of a bird's eye view) according to the present modification. The display control unit 113 recognizes the design drawing 202 and positions of the plurality of photographing point icons 200 displayed on the design drawing 202. Then, the display control unit 113 sets a space (referred to as an icon arrangement space) in which the photographing point icon 200 is arranged as the selectable area 203. In other words, the display control unit 113 sets an area having a high possibility of being photographed by the photographing operation of the photographer as the selectable area 203. For example, the photographing point icon 200 is arranged in a hallway C, a room RM1, and a room RM2 illustrated in FIG. 12. It is highly likely that these spaces are photographed by the photographing operation of the photographer. In other words, it is highly likely that objects present in these areas have been photographed. Therefore, the display control unit 113 sets these spaces as the selectable area 203. The display control unit 113 also sets, as the selectable area 203, a space that communicates with the icon arrangement space and therefore can be handled as substantially the same space as the icon arrangement space. For example, the photographing point icon 200 is not arranged in a room RM3 illustrated in FIG. 12. Here, it is assumed that information indicating that the room RM2 and the room RM3 communicate with each other is stored in a predetermined storage region of the memory 12. In this case, the display control unit 113 sets the room RM3 as the selectable area 203. As described in the foregoing, the display control unit 113 creates the design drawing 202 on which the selectable area 203 is superimposed.

Next, the display control unit 113 presents the design drawing 202 to the user. At this time, the display control unit 113 displays, on the display 23, the selectable area 203 in an emphasized manner. For example, the design drawing 202 in which the selectable area 203 is colored green is displayed on the display 23.

Next, the user selects any region from the selectable area 203. The information terminal 20 that has received this selection transmits a selection result of the user to the display control unit 113. Here, it is assumed, for example, that the user selects a region indicated by a point P in FIG. 12.

Subsequently, the display control unit 113 that has acquired the selection result of the user specifies an object present at the point P. First, the display control unit 113 specifies a photographing point icon (referred to as a corresponding icon) associated with an image in which the object present at the point P appears. Here, it is highly likely that the object existing at the point P appears in an image associated with a photographing point icon existing at a position closest to the point P. Therefore, the display control unit 113 specifies the photographing point icon existing at the position closest to the point P as a corresponding icon. For example, the display control unit 113 specifies a photographing point icon 250 illustrated in FIG. 12 as a corresponding icon. At this time, the display control unit 113 sets a vector extending from the photographing point icon 250 toward the point P.

Subsequently, the display control unit 113 specifies an object (referred to as a corresponding object) present at the point P on the basis of an image (referred to as a corresponding image) associated with the photographing point icon 250. First, the display control unit 113 grasps a relative positional relationship between the photographing point icon 250 and the point P on the basis of the vector. For example, the display control unit 113 grasps that the point P exists at a position 100 pixels away from the photographing point icon 250 in a -X direction. The -X direction is a minus direction of a coordinate axis in a horizontal direction of the design drawing 202. Next, the display control unit 113 analyzes the corresponding image to specify, from the corresponding image, a region corresponding to the position 100 pixels away from the photographing point icon in the -X direction. Then, an object (e.g., the pillar 301) drawn in this region is specified. Then, the display control unit 113 estimates the above object as an object selected by the user.

According to the configuration of the present modification, an object selected from the design drawing 202 by the user is estimated as a predetermined object. Therefore, the user can select a predetermined object more easily as compared with a case where manipulation is performed of opening the first image, searching the first image for a predetermined object by performing the swipe manipulation or the like, and selecting the predetermined object.

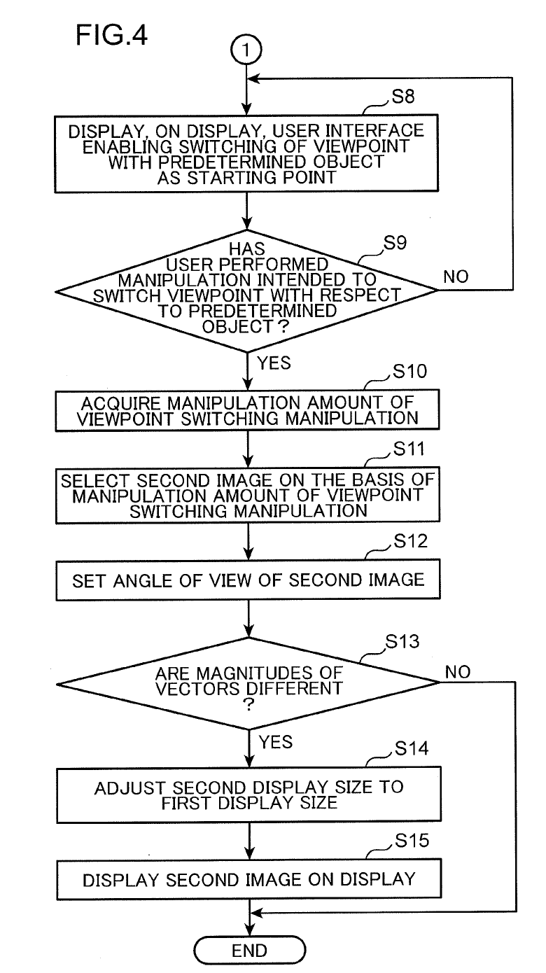

(5) Although in the first embodiment, the description has been made of the example in which the processing of adjusting the second display size to the first display size is executed, this processing is not essential. In other words, the processing of step S8 in FIG. 3, and the processing of step S14 and step S15 in FIG. 4 can be omitted. Whether or not to omit these processing may be set in advance by the user.

(6) Although in the first embodiment, the description has been made of the example in which the second image is selected in response to the detection of the viewpoint switching manipulation, the detection of the viewpoint switching manipulation is not essential. The display control unit 113 may select the second image IM2 in response to detection that the user has selected a predetermined object.

(7) The display control unit 113 may determine whether or not an object corresponding to the pillar 301 appears in the second image candidate. For example, the display control unit 113 acquires a first feature value indicating a shape, a size, a color, and the like of the pillar 301 in the first image. Then, using the first feature value, it may be determined whether or not an object (an object corresponding to the pillar 301) having a similarity to the pillar 301 equal to or higher than a predetermined reference similarity is included in the second image candidates. Then, an image including no object corresponding to the pillar 301 may be excluded from the second image candidates. In this way, it is possible to suppress an inappropriate image from being included in the second image candidates. Specifically, it is possible to exclude an image in which the pillar 301 does not appear, an image in which the pillar 301 is out of focus, and the like from the second image candidates.

The technique according to the present disclosure is useful in a technical field of displaying an image on a display or the like.

1. An information processing method in a computer, comprising:
displaying a bird's eye view on a display;
displaying, on the bird's eye view, a plurality of photographing point icons indicating photographing points;
detecting that a specific icon among the plurality of photographing point icons has been selected;
displaying a first image associated with the specific icon on the display;
detecting that a predetermined object included in the first image has been selected; and
in response to selection of the predetermined object, displaying, on the display, a second image including the predetermined object photographed from a photographing point different from a photographing point of the first image, the second image being captured at a time different from a photographing time of the first image.

2. The information processing method according to claim 1, further comprising:
selecting images associated with photographing point icons present within a predetermined distance from the specific icon as second image candidates; and
selecting the second image from the second image candidates.

3. The information processing method according to claim 2, further comprising:
detecting that viewpoint switching manipulation for the first image has been input; and
acquiring a manipulation amount of the viewpoint switching manipulation,
wherein the second image candidates include at least two images, and
displaying the second image on the display includes selecting the second image from the second image candidates on the basis of the manipulation amount.

4. The information processing method according to claim 3, wherein
selecting the second image from the second image candidates includes:
specifying a positional relationship between a photographing point of the second image candidate and a position of the predetermined object;
on the basis of the positional relationship, calculating a rotation angle formed by a reference direction set in the second image candidate and a direction extending toward the predetermined object with the photographing point of the second image candidate as a starting point; and
selecting the second image candidate having the rotation angle according to the manipulation amount as the second image.

5. The information processing method according to claim 1, further comprising:
acquiring a first display size of the predetermined object in the first image, wherein
displaying the second image on the display includes:
setting a second display size of the predetermined object in the second image to be the same size as the first display size by enlarging or reducing the predetermined object in the second image; and
displaying the second image including the predetermined object set to the same size on the display.

6. The information processing method according to claim 1, further comprising: displaying, on the display, the bird's eye view in which an attention point icon indicating a photographing point of the second image among the plurality of photographing point icons is emphasized.

7. The information processing method according to claim 6, further comprising: setting a color of a frame surrounding the second image and a color of a frame surrounding the attention point icon to the same color.

8. The information processing method according to claim 1, wherein
detecting that the predetermined object has been selected includes:
detecting an object included in the first image;
displaying, on the display in an emphasized manner, an object region in which the detected object is drawn; and
receiving selection of the object region.

9. The information processing method according to claim 1, wherein
detecting that the predetermined object has been selected includes:
displaying, on the display, the bird's eye view in which a selectable area is set;
detecting that a user has selected a predetermined region in the selectable area;
specifying a photographing point icon associated with an image obtained by photographing the predetermined region;
specifying a corresponding region corresponding to the predetermined region from the image obtained by photographing the predetermined region; and
estimating an object included in the corresponding region as the predetermined object.

10. An information processing device including a processor, wherein
the processor executes:
displaying a bird's eye view on a display;
displaying, on the bird's eye view, a plurality of photographing point icons indicating photographing points;
detecting that a specific icon among the plurality of photographing point icons has been selected;
displaying a first image associated with the specific icon on the display;
detecting that a predetermined object included in the first image has been selected; and
in response to selection of the predetermined object, displaying, on the display, a second image including the predetermined object photographed from a photographing point different from a photographing point of the first image, the second image being captured at a time different from a photographing time of the first image.

11. A non-transitory computer readable recording medium storing an information processing program causing a computer to execute:
displaying a bird's eye view on a display;
displaying, on the bird's eye view, a plurality of photographing point icons indicating photographing points;
detecting that a specific icon among the plurality of photographing point icons has been selected;
displaying a first image associated with the specific icon on the display;
detecting that a predetermined object included in the first image has been selected; and
in response to selection of the predetermined object, displaying, on the display, a second image including the predetermined object photographed from a photographing point different from a photographing point of the first image, the second image being captured at a time different from a photographing time of the first image.
